(19) United States
(12) Patent Application Publication
(10) Pub. No.: US 2005/0200064 A1
(43) Pub. Date: Sep. 15, 2005

(54) Holding element for connecting a rod to the body of a vehicle using an elastic bearing

(76) Inventors: Norbert Klein, Germering (DE); Frank-Uwe Diener, Tuttlingen (DE)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 10/513,529

(22) PCT Filed: Jun. 25, 2003
(86) PCT No.: PCT/DE03/02117

§ 371 Date: Nov. 4, 2004

(30) Foreign Application Priority Data
Jun. 27, 2002 (DE) 02 28 653.1

(51) Int. Cl. B60G 11/22

(52) U.S. Cl. 267/293; 280/124.177

(57) ABSTRACT

The invention relates to a holding element for connecting a rod (1) to the body or the chassis of a vehicle using an elastic bearing (2). Said bearing consists of at least one outer sleeve and one inner sleeve (3, 4) provided with an elastic material (5), especially a rubber material, in the annular region (6) between the two sleeves. The outer sleeve (3) is fixed to the body or the chassis, and the inner sleeve (4) is connected to the rod (1) by means of a pin (7). Said pin extends through the inner sleeve (4) and carries a securing disk (9) on its free end, which secures the elastic bearing (2) against damaging offset in the event of defective adhesion of its individual parts in the axial direction. Furthermore, the securing disk extends in the radial direction at least to the outer sleeve (3) and at least part of its outer circumference is embodied in such a way that it is oriented in an essentially concave manner away from the elastic bearing (2). Said adaptation of the securing disk (9) significantly increases the section modulus of the same, enabling a relatively thin securing disk (9) to be used.

The invention relates to a holding element for connecting a rod to the body or the chassis of a vehicle by means of an elastic bearing according to the preamble of the main claim.

The DE 39 25 107 A1 among others is describing a suspension for a vehicle in which a mounting element for the rod is held by means of a first and a second holding element from the inner side and the outer side, respectively, wherein the mounting member is projecting through the side of the body of the vehicle. FIGS. 32 and 33 of DE 39 25 107 A1 in this connection are showing an elastic holding element of a rod on a body by means of a rubber bearing positioned on a bolt fixed to the rod. The rubber bearing is fixed on the bolt by means of a screw nut in an axial direction, wherein between the nut and an inner sleeve of the rubber bearing two disks are positioned. One of these is a spring disk for securing the nut and the other has the purpose to support the rubber material during a large deformation in an axial direction. The outer circumferential rim of the supporting disk is bent outwardly away from the rubber bearing. On this outwardly bent circumferential rim a covering cap is fixed.

German Patent 937564 is describing an elastic bearing connecting a rod with a body. The elastic bearing is fixed to the rod by means of a hexagonal machine screw passing through the bearing and the rod and a hexagonal nut screwed thereon. Between the hexagonal nut and the inner sleeve of the elastic bearing, a washer is positioned slightly concavely outwardly directed to the free end of the elastic bearing. This washer is overlying the circumference of the outer sleeve of the elastic bearing at the free end thereof with the external circumference to form an abutment for the rubber bearing under axial load. The exterior flank of the rubber is parallelly positioned in a distance with respect to the interior surface of the washer to avoid the occurrence of transverse forces in the case of an axial support.

It is the task to be solved by the present invention to provide for a holding element for connecting a rod to the body or the chassis of a vehicle by means of an elastic bearing in which the rod on one side is connected with the rubber bearing in such a way that the latter cannot be displaced axially in case the adherence of the rubber bearing is defective leading to a substantial deterioration of the driving properties of the vehicle.

This task according to the invention is solved by the characterizing features of claim 1. Further improvements of the invention can be learnt from the sub-claims.

According to the invention, a holding element for connecting a rod to the body or the chassis of a vehicle by means of an elastic bearing consisting of at least one outer sleeve and one inner sleeve provided with an elastic material, especially a rubber material, in the annular space remaining there-between, wherein the outer sleeve is fixed to the body or the chassis and the inner sleeve is fixed to the rod by means of a bolt which is passing through the inner sleeve and which is carrying a securing disk on its free end which secures the elastic bearing against a damaging offset in the event of defective adhesion of its individual parts in the axial direction by extending at least up to the outer sleeve in a radial direction, wherein at least a part of its outer circumference is embodied in such a way that it is oriented in an essentially concave manner away from the elastic bearing.

This has the advantage that by the use of only one disk the weight and the costs of the holding element are decreased. The substantially increased section modulus of the adaptation of the securing disk enables the use of a comparatively thin securing disk. Further, the elastic bearing cannot slide out of the bushing due to defective adhesion.

A preferred embodiment according to the invention is characterized in that the securing disk at least over a part of its outer circumference is bent away from the elastic bearing such that a nut screwed onto the free end of the bolt or the head of a machine screw is held safely against rotation.

In an advantageous way therefore the safety against rotation and loss is combined in a simple way.

In an advantageous embodiment according to the invention the securing disk is bent several times, especially three times, away from the elastic bearing over a part of its circumference, whereby the section modulus is optimally increased.

Two preferred embodiments of the invention are more detailly described in the specification below and the drawings. In the drawings show:

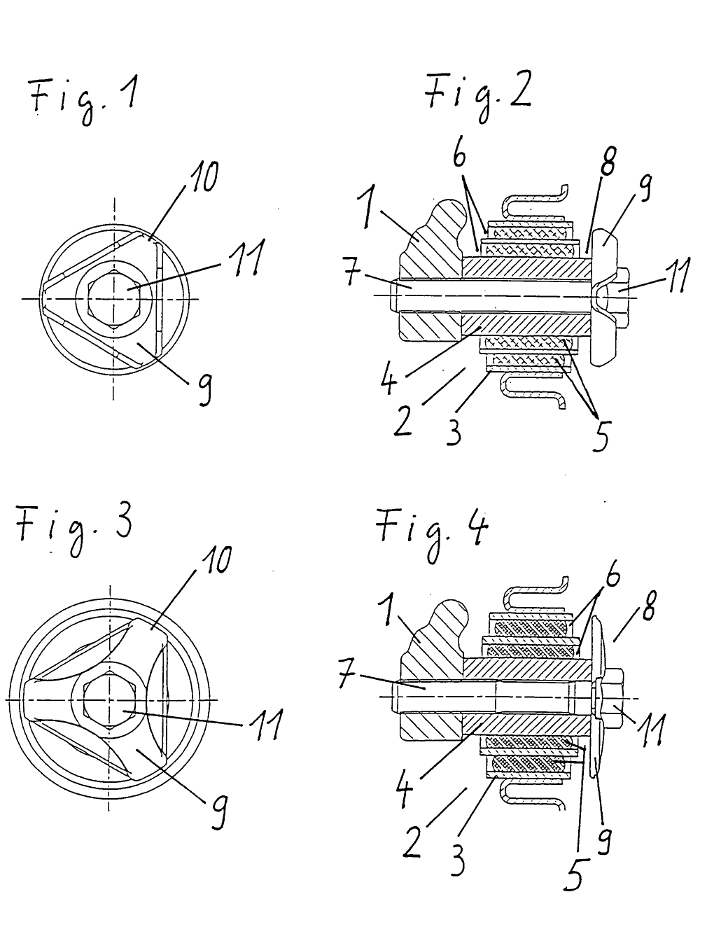

FIG. 1 and FIG. 2 each a top view and a cross-sectional view of a holding element with an elastic bearing according to the invention,

FIG. 3 and FIG. 4, corresponding to FIGS. 1 and 2, a different embodiment of the invention.

In FIG. 1 and FIG. 2 a holding element for connecting a rod 1 to a body not shown or a chassis not shown of a non-shown vehicle via an elastic bearing 2 is shown. The latter is consisting at least of an outer and an inner sleeve 3, 4 with an elastic material 5, especially a rubber material, in the annular region 6 remaining there-between. The outer sleeve 3 is fixed to the body or the chassis and the inner sleeve 4 is connected with the rod 1 by means of a pin 7 or a machine screw 11. The same is extending through the inner sleeve 4 and is carrying at the free end 8 thereof a securing disk 9, which is securing the elastic bearing 2 against damaging offset in the event of defective adhesion of its individual parts in the axial direction. To this end, it is extending in a radial direction at least up to the outer sleeve 3 and at least a part of its outer circumference 10 is shaped essentially in a concave manner away from the elastic bearing 2. This adaptation of the securing disk 9 significantly increases the section modulus of the same enabling a relatively thin securing disk 9 to be used.

FIGS. 3 and 4 are showing a preferred embodiment of the invention which in addition to the features described with reference to FIGS. 1 and 2 with the same reference numerals is characterized in that the securing disk 9 is bent three times over a part of its outer circumference 10 away from the elastic bearing 2 in such a way that the head of the machine screw 11 is securely held against rotation.

1. Holding element for connecting a rod (1) to the body or the chassis of a vehicle by means of an elastic bearing (2) consisting at least of one outer and one inner sleeve (3, 4) provided with an elastic material (5), especially a rubber material, in the annular region (6) remaining there-between, wherein the outer sleeve (3) is fixed to the body or the chassis and the inner sleeve (4) is connected with the rod (1) by means of a pin (7) which is extending through the inner sleeve (4) and is carrying a securing disk (9) on its free end which secures the elastic bearing (2) against damaging offset in the event of defective adhesion of its individual parts in the axial direction by extending in the radial direction at least to the outer sleeve (3), characterized in that the securing disk (9) at least over a part of its outer circumference (10) is shaped basically concave away from the elastic bearing (2).

2. Holding element according to claim 1, characterized in that the securing disk (9) at least over a part of its outer circumference (10) is bent away from the elastic bearing (2) in such a way that thereby a nut screwed onto the free end (8) of the pin (7) or the head of a machine screw (11) is held securely against rotation.

3. Holding element according to claim 2, characterized in that the securing disk (9) is bent several times, at least three times, over a part of its outer circumference (10) away from the elastic bearing (2).
